(19) United States
(12) Patent Application Publication
(10) Pub. No.: US 2019/0363534 A1
(43) Pub. Date: Nov. 28, 2019

(54) THERMAL PROTECTION DEVICE FOR SINGLE-PHASE DUAL-VOLTAGE MOTOR

(71) Applicant: GP Enterprises Co., Ltd., Suzhou (CN)

(72) Inventor: Xian Wang, Suzhou (CN)

(21) Appl. No.: 16/436,888

(22) Filed: Jun. 10, 2019

Related U.S. Application Data
(63) Continuation of application No. PCT/CN2018/091313, filed on Jun. 14, 2018.

(30) Foreign Application Priority Data
May 25, 2018 (CN) 201810512364.6

(51) Int. Cl. H02H 7/085; H02K 11/25; H02K 17/10; H02P 29/02

(52) U.S. Cl. CPC H02H 7/085; H02P 29/02; H02K 17/10; H02K 11/25

(57) ABSTRACT

The present invention discloses a thermal protection device for a single-phase dual-voltage motor, comprising a motor winding, a small-current thermal protector, a large-current thermal protector, wherein the motor winding comprises a main phase winding or comprises a main phase winding and a secondary phase winding, the main phase winding is divided into two portions comprising a first main phase winding and a second main phase winding. According to the above description, in the present invention, two different large and small thermal protectors are used to implement a thermal protection function at different voltages for the single-phase dual-voltage motor by means of an appropriate connection of the circuit, and both use of the protector that can be bound on the stator coil and adoption of a solution in which the slide switch substitutes for the conventional relay significantly reduce the cost and shorten the delivery time, thereby improving the product competitiveness.

### CROSS REFERENCE TO RELATED APPLICATIONS

The present application is a Continuation Application of PCT Application No. PCT/CN2018/091313 filed on Jun. 14, 2018, which claims the benefit of Chinese Patent Application No. 201810512364.6 filed on May 25, 2018. All the above are hereby incorporated by reference.

### TECHNICAL FIELD

The present invention relates to the application technology field of protectors, and in particular to a thermal protection device for a single-phase dual-voltage motor.

### BACKGROUND OF THE INVENTION

Generally, the thermal protectors selected for single-phase dual-voltage motors use the specially designed dual-voltage thermal protectors. The technologies of such protectors are all in the hands of a few companies, the price is high, most of them are external protectors which need to be externally mounted on the end cover or motor housing that is designed to have a mounting position, the motor size is made relatively large, and the mounting is relatively complex. Therefore, the motor cost is increased and the delivery time is prolonged, such protectors thus cannot adapt to the intense competition needs of the market.

### SUMMARY OF THE INVENTION

The technical problem to be mainly solved by the present invention is to provide a thermal protection device for a single-phase dual-voltage motor, wherein one thermal protector with both high and low voltage protection functions is changed to two different large and small thermal protectors for respective implementations, and a thermal protection function at different voltages for the single-phase dual-voltage motor is implemented by means of a slide switch and an appropriate connection of the circuit; in addition, use of the slide switch as a substitute for the conventional relay reduces the cost, and use of the thermal protector that can be bound on the stator coil saves the motor space, without additionally designing a placing position on the component. Therefore, the motor size can be made relatively small, the cost is significantly reduced, and the delivery time is shortened, thereby improving the product competitiveness.

To solve the above-described technical problem, the present invention adopts the following technical solution: a thermal protection device for a single-phase dual-voltage motor is provided, comprising a motor winding, a small-current thermal protector, a large-current thermal protector, and a two-way switch, wherein the motor winding comprises a main phase winding or comprises a main phase winding and a secondary phase winding, the main phase winding is divided into two portions comprising a first main phase winding and a second main phase winding, the small-current thermal protector is connected in series to the first main phase winding, the large-current thermal protector is connected in series to the second main phase winding or is connected in series to the second main phase winding and the secondary phase winding, one end of the small-current thermal protector and one end of the large-current thermal protector are further respectively connected to power input ends, and the two-way switch is respectively connected to the small-current thermal protector, the large-current thermal protector, an output end of the first main phase winding, and the other end of the second main phase winding.

In a preferred embodiment of the present invention, a connection manner between the first main phase winding and the second main phase winding is: a high pressure series connection and a low pressure parallel connection between the first main phase winding and the second main phase winding are completed by means of the two-way switch.

In a preferred embodiment of the present invention, the small-current thermal protector adopts a thermal protector carrying a current of 0-40 A, and the large-current thermal protector adopts a thermal protector carrying a current of 0-80 A.

In a preferred embodiment of the present invention, when the power input ends are supplied with a high voltage for working, the small-current thermal protector works; and when the power input ends are supplied with a low voltage for working, the large-current thermal protector works.

In a preferred embodiment of the present invention, the two-way switch is one of a slide switch and a button rocker switch and adopts six contacts comprising contacts 1, 2, 3, 4, 5, and 6.

In a preferred embodiment of the present invention, contact 5 and contact 6 are in a short-circuit connection to each other.

In a preferred embodiment of the present invention, when the power input ends are supplied with a low voltage for working, contact 1 is connected to contact 3, and contact 2 is connected to contact 4.

In a preferred embodiment of the present invention, when the power input ends are supplied with a high voltage for working, contact 3 is connected to contact 5, and contact 4 is connected to contact 6.

In a preferred embodiment of the present invention, the magnitude of the high voltage is two times of that of the low voltage.

In a preferred embodiment of the present invention, the single-phase dual-voltage motor adopts one of a capacitor run motor, a capacitor start motor, a resistor start motor, a capacitor run-start motor, a series-wound motor, and a shaded-pole motor.

The beneficial effects of the present invention are as follows: in the thermal protection device for a single-phase dual-voltage motor of the present invention, one thermal protector with both high and low voltage protection functions is changed to two different large and small thermal protectors for respective implementations, and a thermal protection function at different voltages for the single-phase dual-voltage motor is implemented by means of a slide switch and an appropriate connection of the circuit; in addition, use of the slide switch as a substitute for the conventional relay reduces the cost, and use of the thermal protector that can be bound on the stator coil saves the motor space, without additionally designing a placing position on the component. Therefore, the motor size can be made relatively small, the cost is significantly reduced, and the delivery time is shortened, thereby improving the product competitiveness.

### BRIEF DESCRIPTION OF THE DRAWINGS

In order to more clearly illustrate the technical solutions in the embodiments of the present invention, the drawings used in the description of the embodiments will be briefly described below, obviously, the drawings in the following description are merely some embodiments of the present invention, for those who skilled in the art, other drawings may also be obtained based on these drawings without paying any creative work.

FIG. 1 is a circuit diagram of a thermal protection device for a single-phase dual-voltage motor in a preferred embodiment of the present invention, which is a circuit diagram of a thermal protection device applicable to a connection to a shaded-pole motor and a series-wound motor;

FIG. 2 is a circuit diagram of a thermal protection device connected to a capacitor run motor in a method in which a secondary phase winding is supplied with a low pressure;

FIG. 3 is a circuit diagram of a thermal protection device connected to a capacitor run motor in a method in which a secondary phase winding is supplied with a high pressure;

FIG. 4 is a circuit diagram of a thermal protection device connected to a capacitor start motor in a method in which a secondary phase winding is supplied with a low pressure;

FIG. 5 is a circuit diagram of a thermal protection device connected to a capacitor start motor in a method in which a secondary phase winding is supplied with a high pressure;

FIG. 6 is a circuit diagram of a thermal protection device connected to a resistor start motor in a method in which a secondary phase winding is supplied with a low pressure;

FIG. 7 is a circuit diagram of a thermal protection device connected to a resistor start motor in a method in which a secondary phase winding is supplied with a high pressure;

FIG. 8 is a circuit diagram of a thermal protection device connected to a capacitor run-start motor in a method in which a secondary phase winding is supplied with a low pressure; and

FIG. 9 is a circuit diagram of a thermal protection device connected to a capacitor run-start motor in a method in which a secondary phase winding is supplied with a high pressure.

The reference numbers in the drawings are as follows: 1: the first main phase winding, 2: the second main phase winding, 3: the small-current thermal protector, 4: the large-current thermal protector, 5: the two-way switch, 6: the secondary phase winding, 7: a running capacitor, 8: a centrifuge, and 9: a starting capacitor.

### DETAILED DESCRIPTION OF THE PREFERRED EMBODIMENTS

The technical solutions in the embodiments of the present invention are clearly and completely described below, obviously, the described embodiments are merely some but not all embodiments of the present invention. All other embodiments obtained by a person skilled in the art based on the embodiments of the present invention without paying creative efforts shall fall within the protection scope of the present invention.

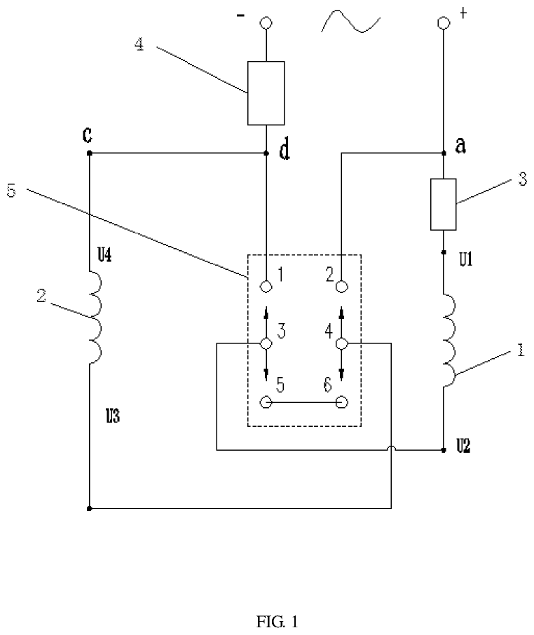

As shown in FIG. 1, an embodiment of the present invention includes:

a thermal protection device for a single-phase dual-voltage motor, including a motor winding, a small-current thermal protector 3, a large-current thermal protector 4, and a two-way switch 5, wherein the motor winding includes a main phase winding or includes a main phase winding and a secondary phase winding, the main phase winding is divided into two portions including a first main phase winding 1 and a second main phase winding 2, one end of the small-current thermal protector 3 is connected in series to one end U1 or the other end U2 of the first main phase winding 1, the other end of the small-current thermal protector 3 and one end of the large-current thermal protector 4 are further respectively connected to power input ends, the other end of the large-current thermal protector 4 is connected in series to one end U4 of the second main phase winding 2, and the two-way switch 5 is respectively connected to the small-current thermal protector 3, the large-current thermal protector 4, the other end U2 of the first main phase winding 1, and the other end U3 of the second main phase winding 2.

In the above description, the first main phase winding 1 and the second main phase winding 2 are connected to each other in series or in parallel.

In this embodiment, the low-current thermal protector 3 adopts a thermal protector carrying a current of 0-40 A, for example, a 17 AM thermal protector or other similar thermal protectors, and is used for thermal protection for the motor at a high voltage; the large-current thermal protector 4 adopts a thermal protector carrying a current of 0-80 A, for example, an 8 AM thermal protector or a similar thermal protector, and is used for thermal protection for the motor at a low voltage.

Further, the two-way switch 5 can be one of a slide switch and a button rocker switch and adopts six contacts including contacts 1, 2, 3, 4, 5, and 6. Switching between high and low pressure lines is implemented by moving a slide block, where contact 5 and contact 6 are brought into a short-circuit connection to each in advance.

When the power input ends are supplied with a low voltage for working, contact 1 is connected to contact 3, and contact 2 is connected to contact 4; and when the power input ends are supplied with a high voltage for working, contact 3 is connected to contact 5, and contact 4 is connected to contact 6. The magnitude of the high voltage is two times of that of the low voltage, for example, 230/115 V, 460/230 V, and the like.

When the circuit is further extended, the thermal protection device for the single-phase dual-voltage motor further includes a secondary phase winding 6, where one end A1 of the secondary phase winding 6 is connected to one end U2 or the other end U1 of the first main phase winding 1, and the other end A2 of the secondary phase winding 6 is connected to one end U4 of the second main phase winding 2 directly or indirectly (or by means of a capacitor or a centrifuge).

In a high voltage connection, the small-current thermal protector 3 is connected in series to the first main phase winding 1, the two windings of the first main phase winding 1 and the second main phase winding 2, in which the second main phase winding 2 is further connected in parallel to the secondary phase winding 6, are connected in series to each other and then are connected to the large-current thermal protector 4. When the motor operates abnormally, the temperature sensed by the small-current thermal protector 3 reaches to a cut-off temperature, the circuit is cut off, and the first main phase winding 1, the second main phase winding 2, and the secondary phase winding 6 are all powered off, so as to protect the motor winding from being burned out.

In a low voltage connection, the small-current thermal protector 3 is connected in series to the first main phase winding 1, the three coils of the first main phase winding 1, the second main phase winding 2, and secondary phase winding 6 are connected in parallel to each other and then are connected to the large-current thermal protector 4. When the motor operates abnormally, the temperature sensed by the large-current thermal protector 4 reaches to a cut-off temperature, the circuit is cut off, and the first main phase winding 1, the second main phase winding 2, and the secondary phase winding 6 are all powered off, so as to protect the motor winding from being burned out.

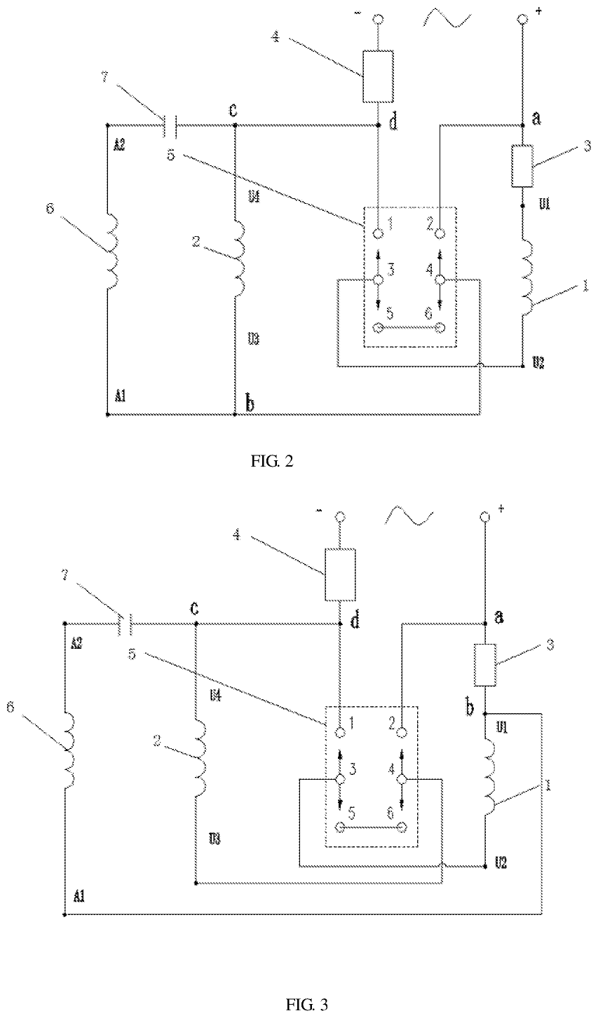

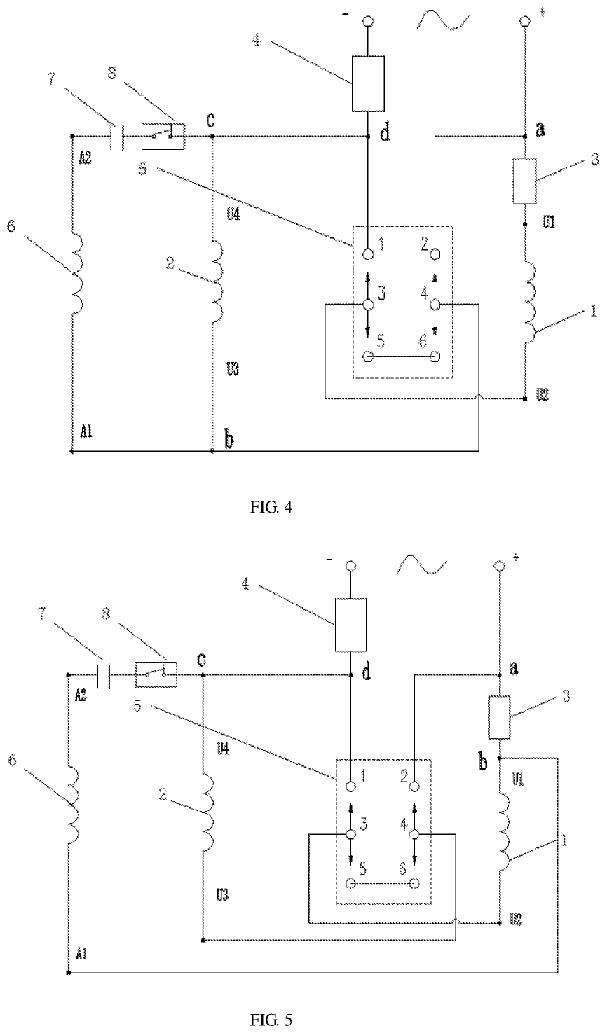

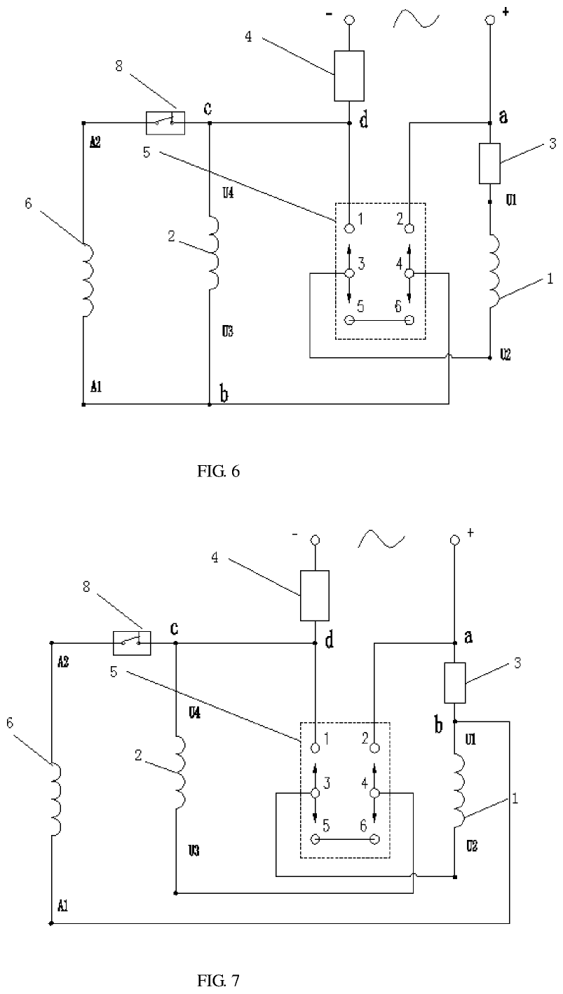

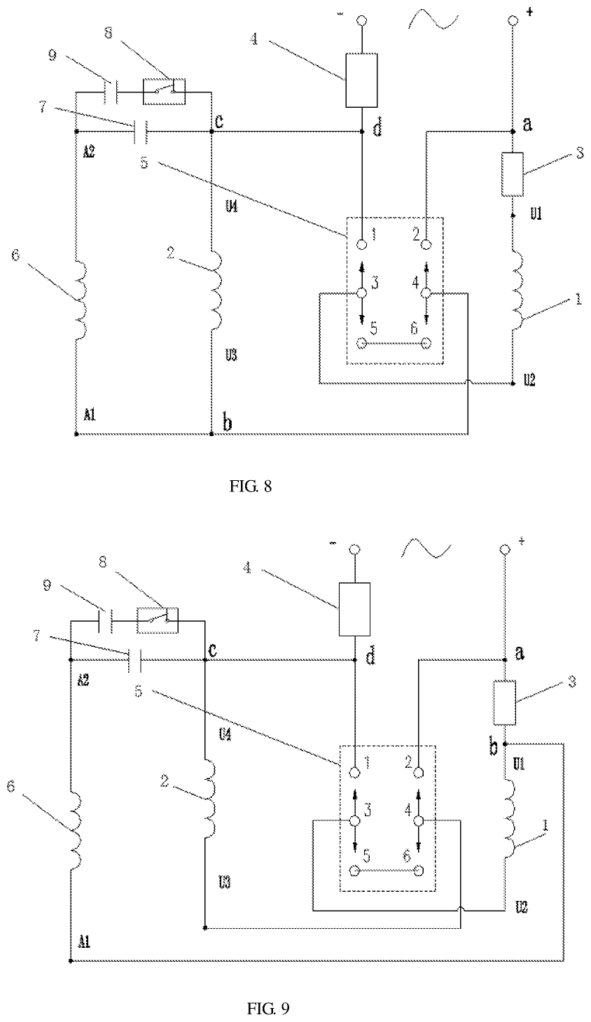

FIG. 2 to FIG. 9 are applicable to a single phase-type dual-voltage motor. In this embodiment, the single-phase dual-voltage motor 7 can be one of a capacitor run motor, a capacitor start motor, a resistor start motor, a capacitor run-start motor, a series-wound motor, and a shaded-pole motor.

Referring to FIG. 2, detailed description is performed only for the capacitor run motor:

1. When the power input ends are supplied with a high voltage, a current at one end passes through a node a, passes through the small-current thermal protector 3, enters into the first main phase winding 1, then flows into the two-way witch 5, sequentially passes through contacts 3, 5, 6, and 4, and flows into a node b. The secondary phase winding 6 and the second main phase winding 2 are connected in parallel to each other, in which case the current is divided into two parallel currents, where one current flows into the second main phase winding 2; and the other current flows into the secondary phase winding 6 and flows through the capacitor to converge with the current passing through second main phase winding 2 into a node c, then a resultant current flows through a node d, enters into the large-current thermal protector 4, and enters into the other end of the power input ends, so as to complete a high pressure loop.

Note: In the method in which the secondary phase winding is supplied with a low voltage, the small-current thermal protector 3 is connected in series to the large-current thermal protector 4 (currents flowing through the two protectors are identical), and due to the small current, the small-current thermal protector 3 plays the protection role, while the large-current thermal protector 4 does not operate.

2. When the power input ends are supplied with a low voltage, a current at one end passes through the node a, in which case the current is divided into two currents, wherein one current passes through the small-current thermal protector 3, enters into the first main phase winding 1, then flows into the two-way switch 5, passes through contacts 3 and 1, flows into the node d, enters into the large-current thermal protector 4, and enters into the other end of the power input ends, so as to complete a loop. The other current flows into the two-way switch 5, sequentially passes through contacts 2 and 4, flows into the node b, then the current is further divided into two parallel currents, where one current flows into the second main phase winding 2; and the other current flows into the secondary phase winding 6 and flows through the capacitor to converge with the current passing through second main phase winding 2 into the node c, then a resultant current flows through the node d, enters into the large-current thermal protector 4, and enters into the other end of the power input ends, so as to complete another loop.

Note: In the method in which the secondary phase winding is supplied with a low voltage, the small-current thermal protector 3 protects the first main phase winding 1, and the large-current thermal protector 4 protects all the first main phase winding 1, the second main phase winding 2, and the secondary phase winding 6.

The thermal protection device for a single-phase dual-voltage motor of the present invention is provided with both two thermal protectors with different protection currents. When a water pump works in a low voltage mode, if motor rotor locking occurs, both currents borne by the small-current thermal protector 3 and the large-current thermal protector 4 reach the protection currents. However, because a set working time of the large-current thermal protector 4 is shorter than a set working time of the small-current thermal protector 3, the large-current thermal protector 4 first operates to cut off the whole circuit. When the water pump works in a high voltage mode, if motor rotor locking occurs, the current borne by the small-current thermal protector 3 reaches the protection current; at this time, the magnitude of the current borne by the large-current thermal protector 4 is the same as that of the current borne by the small-current thermal protector, and the current borne by the large-current thermal protector 4 does not reach the protection current thereof; therefore, the small-current thermal protector operates to cut off the whole circuit, while the large-current thermal protector 4 does not operate.

In conclusion, in the thermal protection device for a single-phase dual-voltage motor of the present invention, one thermal protector with both high and low voltage protection functions is changed to two different large and small thermal protectors, where a thermal protection function at different voltages for the single-phase dual-voltage motor is implemented by means of a slide switch and an appropriate connection of the circuit; in addition, use of the slide switch as a substitute for the conventional relay reduces the cost, and use of the thermal protector that can be bound on the stator coil saves the motor space, without additionally designing a placing position on the component. Therefore, the motor size can be made relatively small, the cost is significantly reduced, and the delivery time is shortened, thereby improving the product competitiveness.

The above description is merely embodiments of the present invention, and does not thereby limit the scope of the patent for the present invention. Any equivalent structure or process transformations made by using the contents in the specification of the present invention which are directly or indirectly applied to other related technical fields shall be included in the patent protection scope of the present invention.

What is claimed is:

1. A thermal protection device for a single-phase dual-voltage motor, comprising a motor winding, a small-current thermal protector, a large-current thermal protector, and a two-way switch, wherein the motor winding comprises a main phase winding or comprises a main phase winding and a secondary phase winding, the main phase winding is divided into two portions comprising a first main phase winding and a second main phase winding, the small-current thermal protector is connected in series to the first main phase winding, the large-current thermal protector is connected in series to the second main phase winding or is connected in series to the second main phase winding and the secondary phase winding, one end of the small-current thermal protector and one end of the large-current thermal protector are further respectively connected to power input ends, and the two-way switch is respectively connected to the small-current thermal protector, the large-current thermal protector, an output end of the first main phase winding, and the other end of the second main phase winding.

2. The thermal protection device for a single-phase dual-voltage motor according to claim 1, wherein a connection manner between the first main phase winding and the second main phase winding is: a high pressure series connection and a low pressure parallel connection between the first main phase winding and the second main phase winding are completed by means of the two-way switch.

3. The thermal protection device for a single-phase dual-voltage motor according to claim 1, wherein the small-current thermal protector adopts a thermal protector carrying a current of 0-40 A, and the large-current thermal protector adopts a thermal protector carrying a current of 0-80 A.

4. The thermal protection device for a single-phase dual-voltage motor according to claim 3, wherein when the power input ends are supplied with a high voltage for working, the small-current thermal protector works; and when the power input ends are supplied with a low voltage for working, the large-current thermal protector works.

5. The thermal protection device for a single-phase dual-voltage motor according to claim 1, wherein the two-way switch is one of a slide switch and a button rocker switch and adopts six contacts comprising contacts 1, 2, 3, 4, 5, and 6.

6. The thermal protection device for a single-phase dual-voltage motor according to claim 5, wherein contact 5 and contact 6 are in a short-circuit connection to each other.

7. The thermal protection device for a single-phase dual-voltage motor according to claim 5, wherein when the power input ends are supplied with a low voltage for working, contact 1 is connected to contact 3, and contact 2 is connected to contact 4.

8. The thermal protection device for a single-phase dual-voltage motor according to claim 5, wherein when the power input ends are supplied with a high voltage for working, contact 3 is connected to contact 5, and contact 4 is connected to contact 6.

9. The thermal protection device for a single-phase dual-voltage motor according to claim 1, wherein the magnitude of the high voltage is two times of that of the low voltage.

10. The thermal protection device for a single-phase dual-voltage motor according to claim 1, wherein the single-phase dual-voltage motor adopts one of a capacitor run motor, a capacitor start motor, a resistor start motor, a capacitor run-start motor, a series-wound motor, and a shaded-pole motor.
